(19) United States
(12) Patent Application Publication
(10) Pub. No.: US 2026/0164244 A1
(43) Pub. Date: Jun. 11, 2026

(54) Mobility Subscriber Malware Detection Through Event Data Record Signature

(71) Applicant: AT&T Intellectual Property I, L.P., Atlanta, GA (US)

(72) Inventor: Sean SIMON, Lynnwood, WA (US)

(21) Appl. No.: 18/940,716

(22) Filed: Nov. 7, 2024

(51) Int. Cl. H04W 12/122; H04L 41/16; H04W 24/08

(52) U.S. Cl. CPC H04W 12/122; H04L 41/16; H04W 24/08

(57) ABSTRACT

A processing system may obtain a plurality of event data record based malware signatures, and monitor a plurality of event data records associated with a mobility communication network. The processing system may then detect at least one event data record of the plurality event data records matching at least one event data record based malware signature of the plurality of event data record based malware signatures and perform at least one remedial action for a mobile endpoint device of a subscriber associated with the at least one event data record matching the at least one event data record based malware signature.

The present disclosure relates generally to wireless communication networks, and more particularly to methods, non-transitory computer-readable media, and apparatuses for detecting infected mobile endpoint devices of subscribers through event data records (EDRs).

### BACKGROUND

Security methods and tools may rely on file signatures to detect malware (broadly malicious files). For example, security tools which can detect malware, threats or malicious behaviors are traditionally based upon Internet Protocol (IP) protocol inspection through passive (Intrusion Detection) or in-line (Intrusion Prevent) placement of security tools combined with a signature database of known malware. Unfortunately, this approach is very costly as it involves network engineering, a large volume of compute and storage resources and the proper placement of security appliances with sufficient density to observe traffic in transit. To illustrate, a plurality of firewall modules can be deployed throughout a communication core network to perform deep packet inspection (DPI) to monitor for malware threats or malicious behaviors. Such comprehensive deployment of a great number of firewall modules are very expensive in both financial cost and computational cost to the network service provider of a communication core network.

### SUMMARY

In one example, the present disclosure discloses a method, computer-readable medium, and apparatus for detecting infected mobile endpoint devices of subscribers through event data records (EDRs). For example, a processing system including at least one processor may obtain a plurality of event data record based malware signatures, monitor a plurality of event data records associated with a mobility communication network, detect at least one event data record of the plurality event data records matching at least one event data record based malware signature of the plurality of event data record based malware signatures, and perform at least one remedial action for a mobile endpoint device of a subscriber associated with the at least one event data record matching the at least one event data record based malware signature.

### BRIEF DESCRIPTION OF THE DRAWINGS

The teachings of the present disclosure can be readily understood by considering the following detailed description in conjunction with the accompanying drawings, in which:

FIG. 1 illustrates a block diagram of an example system, in accordance with the present disclosure;

FIG. 2 illustrates a flowchart of an example method for detecting infected mobile endpoint devices of subscribers through event data records; and

FIG. 3 illustrates an example of a computing device, or computing system, specifically programmed to perform the steps, functions, blocks, and/or operations described herein.

To facilitate understanding, similar reference numerals have been used, where possible, to designate elements that are common to the figures.

### DETAILED DESCRIPTION

It is extremely expensive and costly to apply traditional methods of malware detection. Such methods may involve attempts to mirror traffic links to observe client behaviors. With increases in per-subscriber bandwidth, it is very expensive and challenging to implement these malware detection methods. In addition, due to the costs associated with deploying security tooling within the mobile core network and an elastic micro-service architecture for cloud-native 5G standalone architecture (SA), these approaches require vast amounts of complex and computational resources in order to be successful. Therefore, the likelihood of success of detecting malware or malicious client behavior becomes exponentially more challenging. Evolved Packet Core (EPC) core traffic is primarily proxied in order to supply enhancements for user experience, and/or to conserve Internet Protocol (IP) address space. Subsequently, traffic in-transit on a network may not contain mobility specific attributes which makes reconciliation very difficult without additional batch processing. Information Security related tooling does not natively support mobility-specific subscriber data elements and often requires offline correlation to reconcile traffic to actual mobility subscriber-level details. To illustrate, external IP addresses which are flow-based have to be reconciled with firewall logs to determine what non-proxied address was in use at a particular time. In turn, the internal IP addresses that are re-used must then be reconciled with EDRs to see which subscriber had which IP address in use at a given time.

The present disclosure broadly discloses methods, computer-readable media, and apparatuses for detecting infected mobile endpoint devices of subscribers through event data records. Mobility networks may generate protocol-level event data records at a session protocol level that are used to support numerous business functions such as: performance tuning, billing, troubleshooting, and marketing analysis. EDRs are generated in the billions daily, which may contain subscriber-level details in combination with levels L3 (network layer)—L7 (application layer) details (of an Open Systems Interconnection (OSI) networking reference model) on a per-flow basis.

A cloud radio access network (RAN) is part of the 3^{rd} Generation Partnership Project (3GPP) fifth generation (5G) specifications for mobile networks. As part of the migration of cellular networks towards 5G, a cloud RAN may be coupled to an Evolved Packet Core (EPC) network until new cellular core networks are deployed in accordance with 5G specifications. For instance, a cellular network in a “non-stand alone” (NSA) mode architecture may include 5G radio access network components supported by a fourth generation (4G)/Long Term Evolution (LTE) core network (e.g., an EPC network). However, in a 5G “standalone” (SA) mode point-to-point or service-based architecture, components and functions of the EPC network may be replaced by a 5G core network. Ultimately, 5G may deliver superior high speed and performance. In particular, advancements in radio access network (RAN) technologies include application (app)-based automation, in which new applications, including third-party applications, may be deployed into a RAN operations platform over time.

With the robust proliferation of wireless technologies and ever more reliable network access, mobile endpoint devices (e.g., mobile phones, mobile tablets, laptops, a pair of smart goggles, a pair of smart glasses, Internet of Things (IoT) devices, etc.) have become an integral part of people's lives. For example, mobile phones have tremendous features that allow people to easily stay in touch with loved ones and access important information wherever they are. In addition to making phone calls, mobile phones also allow users to send text messages, emails, and to conduct transactions over the Internet. Unfortunately, mobile phones are also the targets for malware. Often user mobile devices infected with malware may remain undetected for quite some time without the users realizing that their mobile devices have been compromised. For example only, a malware or other malicious codes on an infected mobile endpoint device (or on a device in communication with an uninfected mobile endpoint device) may surreptitiously exfiltrate content from the mobile endpoint device. For example, a user of the mobile endpoint device may unknowingly download an application which includes a malicious code that may impermissibly gather information of the user. The malicious code may also use the mobile endpoint device's own communication capabilities to transmit the user's personal and/or confidential information to another device over a network without the user's knowledge. Often, the unauthorized breach is uncovered only after a significant damage to the user has occurred.

The present disclosure provides a method and apparatus for detecting infected mobile endpoint devices of subscribers through event data records (EDRs). In one embodiment of the present disclosure, an EDR based malware signature database is generated for use for comparative analysis against EDRs which may potentially serve as indicators of the presence of malware or malicious behavior. This approach of analyzing EDRs for known malware through signature development will allow for centralized analysis, detection and alerting of mobility subscribers that their mobile endpoint devices may be infected with malware. In one embodiment, the identification of the subscriber mobile endpoint device is identified directly using the “infected” EDR without performing additional processing outside of the infected EDR. In other words, inspection of the infected EDR can be used to identify the impacted subscriber mobile endpoint device. It should be noted the term “infected EDR” does not mean that the EDR is itself infected with the malware, but is simply referring to an EDR that is correlated to a mobile endpoint device likely infected with a malware that may cause the generation of the pertinent EDR that would suggest the mobile endpoint device being infected with the pertinent malware.

Additional remedial actions can also be taken once the presence of malware is suspected, e.g., sending an update software patch to an infected mobile endpoint device to remove or uninstall the pertinent malware, quarantine the traffic of an infected mobile endpoint device to a dedicated part of the communication network, e.g., a particular slice of the communication network, a honey pot, and the like, or notifying a security system of the communication network to monitor and uncover the malicious behaviors to discover the originating source of the malware or to discover the true intention of the malware, e.g., detecting the type of personal information being stolen, detecting the destination that the stolen information is being sent and aggregated, detecting that the infected mobile endpoint device is being recruited for a future botnet attack, etc.

Thus, a significant advantage of the present disclosure is that the present approach utilizes the billions of EDRs already generated by a communication service provider to detect the presence of malware or infected subscribers'mobile endpoint devices without the needs of distributing traditional security tools which utilize bulk packet captures or security appliances. In addition, the present approach avoids large amounts of financial resources to be spent on the security tooling infrastructure to provide similar capabilities with more comprehensive coverage since EDRs are generated and captured for the entire mobile subscriber population. To provide this same level of coverage, using traditional methods will incur very significant financial resources and will increase the complexity and maintenance of the security tooling infrastructure.

As yet another example, machine learning techniques could be used to assist in the detecting of malware in the present disclosure. For instance, a machine learning module or algorithm could be trained on a plurality of EDR based malware signatures that were previously confirmed to be correlated to known malware. Once the machine learning module or algorithm is trained, the machine learning module or algorithm can be deployed to monitor and analyze the billions of EDRs that are continuously being generated and stored. In one embodiment, the output of the machine learning module or algorithm can be the detection of an EDR based malware signature associated with a known malware that can be traced to a particular mobile endpoint device of a particular user. In another embodiment, the output of the machine learning module or algorithm can be a predictive model or models for accurate forecasting/prediction of the spread of the malware to other mobile endpoint devices. For example, the trained machine learning module or algorithm may be able to detect a previous pattern of malware infection across a mobility communication network based on the EDRs. For example, the historical EDRs may show how one infected mobile endpoint device may eventually infect other mobile endpoint devices unknowingly, e.g., of other mobile endpoint devices of the same user or mobile endpoint devices of the user's friends and family. This predictive output will allow a mobile communication service provider to quickly ascertain how a malware may potentially spread and impact its subscribers across its own mobility communication network, thereby allowing the mobile communication service provider to quickly execute one or more remedial actions.

For instance, the mobility malware detection/forecasting model(s) of the present disclosure may comprise a machine learning model. It should be noted that as referred to herein, a machine learning model (MLM) (or machine learning-based model) may comprise a machine learning algorithm (MLA) that has been “trained” or configured in accordance with input training data to perform a particular service. For instance, a MLM may comprise a deep learning neural network, or deep neural network (DNN), a convolutional neural network (CNN), a recurrent neural network (RNN), a long-short term memory (LSTM) model, a transformer network, an encoder-decoder neural network, an encoder neural network, a decoder neural network, a variational autoencoder, a generative adversarial network (GAN), a decision tree algorithm/model, such as gradient boosted decision tree (GBDT) (e.g., XGBoost, XGBR, or the like), and so forth. In one example, one or more MLMs of the present disclosure may include supervised learning and/or reinforcement learning (e.g., using positive and negative examples after deployment as a MLM), and so forth. In one example, MLAs/MLMs of the present disclosure may be in accordance with an open source library, such as OpenCV, which may be further enhanced with domain-specific training data.

In another example, the mobility malware detection/forecasting model(s) of the present disclosure may not match an event data record of a subscriber's mobile endpoint device exactly to an EDR based malware signature associated with a known malware. However, the event data record of a subscriber's mobile endpoint device may exhibit a significant portion of the EDR based malware signature associated with a known malware (e.g., meeting a predefined threshold, e.g., 90%, 95%, or 98% of the EDR based malware signature associated with a known malware). For instance, the machine learning could be used to determine a baseline for expected device behavior from the EDRs (where the mobile device behavior may be defined in terms of total amount of data consumed over a given time period, amount of data consumed when using specific applications, and/or amount of data consumed during specific times of day). Then, when a deviation from the baseline is detected that is larger than a threshold, an anomaly may be reported and stored. However the detected anomaly may not match exactly to an EDR based signature associated with a known malware. For instance, if a specific user mobile endpoint device never consumes data between the hours of 10:00 PM and 6:00 AM, and suddenly the specific user mobile endpoint device is detected consuming 500 megabytes of data at 2:00 AM, the data consumption at 2:00 AM may be reported as an anomaly. If an EDR based malware signature associated with a known malware contains this type of behavior but requires that a certain amount of data is then subsequently sent to a particular destination port or destination IP address (but that has not occurred yet for this event data record), then although the current event data record under analysis does not technically match the EDR based malware signature associated with a known malware exactly, the mobile device associated with this current event data record under analysis can still be targeted or labelled for more intensive further monitoring since there is a possibility that the last portion of the EDR based malware signature associated with a known malware may simply be delayed. This “partial” malware or “anomaly” detection may again allow a mobility communication service provider to pre-emptively execute a remedial action to stem the possibility of a wider infection across its mobility communication network.

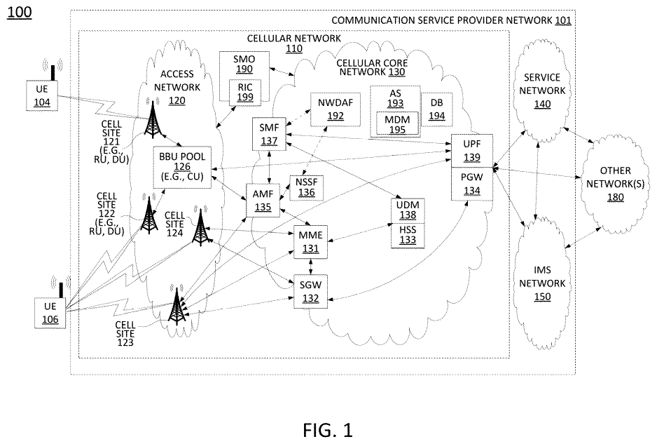

In one example, a detected “partial” malware on a customer mobile endpoint device may first be reported to a customer, in order to give the customer an opportunity to respond before a remedial action is pre-emptively applied to the customer mobile endpoint device, e.g., data access is suspended for the customer mobile endpoint device. For instance, an alert may be send to the customer mobile endpoint device or email requesting that the anomaly be verified as a permitted usage of data. As an example, the customer might be having trouble sleeping and decide to stream a movie. If no response is received from the customer, or if the customer responds and does not justify the anomaly, then data access to the customer mobile endpoint device may be suspended. In other examples, however, the data access to the customer mobile endpoint device may be suspended automatically, e.g., as soon as the anomaly is detected. In this case, the customer may have to respond to a request to justify the anomaly before the data access to the customer mobile endpoint device is restored. These and other aspects of the present disclosure are discussed in greater detail below in connection with the examples of FIGS. 1-3.

To better understand the present disclosure, FIG. 1 illustrates an example network, or system 100 in which examples of the present disclosure may operate. In one example, the system 100 includes a communication service provider network 101. The communication service provider network 101 may comprise a cellular network 110 (e.g., a 4G/Long Term Evolution (LTE) network, a 4G/5G hybrid network, or the like), a service network 140, and an IP Multimedia Subsystem (IMS) network 150. The system 100 may further include other networks 180 connected to the communication service provider network 101.

In one example, the cellular network 110 comprises an access network 120 and a cellular core network (broadly a mobile or mobility communication network) 130. In one example, the access network 120 comprises a cloud RAN. For instance, a cloud RAN is part of the 3GPP 5G specifications for mobile networks. As part of the migration of cellular networks towards 5G, a cloud RAN may be coupled to an Evolved Packet Core (EPC) network until new cellular core networks are deployed in accordance with 5G specifications. In one example, access network 120 may include cell sites 121 and 122 and a baseband unit (BBU) pool 126. In a cloud RAN, radio frequency (RF) components, referred to as remote radio heads (RRHs), may be deployed remotely from baseband units, e.g., atop cell site masts, buildings, and so forth. In an Open RAN (O-RAN) architecture, these may alternatively or additionally be referred to as and/or may include radio units (RUs) (also referred to as O-RUs) and/or distributed units (DUs). In one example, the BBU pool 126 may be located at distances as far as 20-80 kilometers or more away from the antennas/remote radio heads of cell sites 121 and 122 that are serviced by the BBU pool 126. In an O-RAN architecture, these may alternatively or additionally be referred to as and/or may include centralized units (CUs). It should also be noted in accordance with efforts to migrate to 5G networks, cell sites may be deployed with new antenna and radio infrastructures such as multiple input multiple output (MIMO) antennas, and millimeter wave antennas. In this regard, a cell, e.g., the footprint or coverage area of a cell site may in some instances be smaller than the coverage provided by NodeBs or eNodeBs of 3G-4G RAN infrastructure. For example, the coverage of a cell site utilizing one or more millimeter wave antennas may be 1000 feet or less.

Although cloud RAN and or O-RAN infrastructure may include distributed units (DUs), radio units (RUs)/RRHs and centralized units (CU), e.g., baseband units (BBUs), a heterogeneous network may include cell sites where RRH and BBU components (or CUs, DUs, and RUs) remain co-located at the cell site. For instance, cell site 123 may include RRH and BBU components (or an RU, DU, and CU). Thus, cell site 123 may comprise a self-contained “base station.” With regard to cell sites 121 and 122, the “base stations” may comprise RRHs at cell sites 121 and 122 coupled with respective baseband units of BBU pool 126. In accordance with the present disclosure, any one or more of cell sites 121-123 may be deployed with antenna and radio infrastructures, including multiple input multiple output (MIMO) and millimeter wave antennas.

In one example, access network 120 may include both 4G/LTE and 5G radio access network infrastructure. For example, access network 120 may include cell site 124, which may comprise 4G/LTE base station equipment, e.g., an eNodeB. In addition, access network 120 may include cell sites comprising both 4G and 5G base station equipment, e.g., respective antennas, feed networks, baseband equipment, and so forth. For instance, cell site 123 may include both 4G and 5G base station equipment and corresponding connections to 4G and 5G components in cellular core network 130. Although access network 120 is illustrated as including both 4G and 5G components, in another example, 4G and 5G components may be considered to be contained within different access networks. Nevertheless, such different access networks may have a same wireless coverage area, or fully or partially overlapping coverage areas.

In one example, the cellular core network 130 provides various functions that support wireless services in the LTE environment. In one example, cellular core network 130 is an Internet Protocol (IP) packet core network that supports both real-time and non-real-time service delivery across a LTE network, e.g., as specified by the 3GPP standards. In one example, cell sites 121 and 122 in the access network 120 are in communication with the cellular core network 130 via baseband units in BBU pool 126.

In cellular core network 130, network devices such as Mobility Management Entity (MME) 131 and Serving Gateway (SGW) 132 support various functions as part of the cellular network 110. For example, MME 131 is the control node for LTE access network components, e.g., eNodeB aspects of cell sites 121-123. In one embodiment, MME 131 is responsible for UE (User Equipment) tracking and paging (e.g., such as retransmissions), bearer activation and deactivation process, selection of the SGW, and authentication of a user. In one embodiment, SGW 132 routes and forwards user data packets, while also acting as the mobility anchor for the user plane during inter-cell handovers and as an anchor for mobility between 5G, LTE and other wireless technologies, such as 2G and 3G wireless networks.

In addition, cellular core network 130 may comprise a Home Subscriber Server (HSS) 133 that contains subscription-related information (e.g., subscriber profiles), performs authentication and authorization of a wireless service user, and provides information about the subscriber's location. The cellular core network 130 may also comprise a packet data network (PDN) gateway (PGW) 134 which serves as a gateway that provides access between the cellular core network 130 and various packet data networks (PDNs), e.g., service network 140, IMS network 150, other network(s) 180, and the like.

The foregoing describes long term evolution (LTE) cellular core network components (e.g., EPC components). In accordance with the present disclosure, cellular core network 130 may further include other types of wireless network components e.g., 2G network components, 3G network components, 5G network components, etc. Thus, cellular core network 130 may comprise an integrated network, e.g., including any two or more of 2G-5G infrastructures and technologies, and the like. For example, as illustrated in FIG. 1, cellular core network 130 further comprises 5G components, including: an access and mobility management function (AMF) 135, a network slice selection function (NSSF) 136, a session management function (SMF), a unified data management function (UDM) 138, a user plane function (UPF) 139, and a network data analytics function (NWDAF) 192.

In one example, AMF 135 may perform registration management, connection management, endpoint device reachability management, mobility management, access authentication and authorization, security anchoring, security context management, coordination with non-5G components, e.g., MME 131, and so forth. NSSF 136 may select a network slice or network slices to serve an endpoint device, or may indicate one or more network slices that are permitted to be selected to serve an endpoint device. For instance, in one example, AMF 135 may query NSSF 136 for one or more network slices in response to a request from an endpoint device (such as UE 104 or UE 106) to establish a session to communicate with a PDN. The NSSF 136 may provide the selection to AMF 135, or may provide one or more permitted network slices to AMF 135, where AMF 135 may select the network slice from among the choices. A network slice may comprise a set of cellular network components, e.g., network functions (NFs), such as AMF(s), SMF(s), UPF(s), and so forth that may be arranged into different network slices which may logically be considered to be separate cellular networks. A specific set of NFs arranged into a network slice may also be referred to as a network slice instance (NSI). In one example, different network slices may be preferentially utilized for different types of services. For instance, a first network slice may be utilized for sensor data communications, Internet of Things (IoT), and machine-type communication (MTC), a second network slice may be used for streaming video services, a third network slice may be utilized for voice calling, a fourth network slice may be used for gaming services, a fifth network slice may be used for first responder or other governmental services, and so forth.

In one example, SMF 137 may perform endpoint device IP address management, UPF selection, UPF configuration for endpoint device traffic routing to an external packet data network (PDN), charging data collection, quality of service (QoS) enforcement, and so forth. In one example, UDM 138 may perform user identification, credential processing, access authorization, registration management, mobility management, subscription management, and so forth. As illustrated in FIG. 1, UDM 138 may be tightly coupled to HSS 133. For instance, UDM 138 and HSS 133 may be co-located on a single host device, or may share a same processing system comprising one or more host devices. In one example, UDM 138 and HSS 133 may comprise interfaces for accessing the same or substantially similar information stored in a database on a same shared device or one or more different devices, such as subscription information, endpoint device capability information, endpoint device location information, and so forth. For instance, in one example, UDM 138 and HSS 133 may both access subscription information or the like that is stored in a unified data repository (UDR) (not shown).

UPF 139 may provide an interconnection point to one or more external packet data networks (PDN(s)) and perform packet routing and forwarding, QoS enforcement, traffic shaping, packet inspection, and so forth. In one example, UPF 139 may also comprise a mobility anchor point for 4G-to-5G and 5G-to-4G session transfers. In this regard, it should be noted that UPF 139 and PGW 134 may provide the same or substantially similar functions, and in one example, may comprise the same device, or may share a same processing system comprising one or more host devices.

As noted above, cellular core network 130 further includes NWDAF 192, which may be tasked monitoring various network functions, network slices, and access network components. In one example, NWDAF 192 may subscribe to data analytics (e.g., performance indicators/KPIs) from a variety of NFs, may store these analytics, and may provide such analytics to other NFs that may request such data. For instance, NSSF 136 may obtain slice load level analytics which may be used by NSSF 136 to select a network slice or network slices to serve an endpoint device, or may indicate one or more network slices that are permitted to be selected to serve an endpoint device. For instance, AMF 135 may query NSSF 136 for one or more network slices in response to a request from an endpoint device to establish a session to communicate with a PDN (e.g., which may be represented by other network(s) 180 in FIG. 1). The NSSF 136 may provide the selection to AMF 135, or may provide one or more permitted network slices to AMF 135, where AMF 135 may select the network slice from among the choices. In one example, AMF 135 may utilize additional information such as a UE/subscriber class or category from HSS 133. For example, when a slice is indicated to have a particular load level above a threshold, UEs/subscribers of one or more defined classes/categories may be prevented from accessing the slice, or may have preferential access to the slice over other classes/categories, and so forth. In accordance with the present disclosure, in one example NWDAF 192 may track various performance indicators with respect to access network 120 and/or regarding particular components thereof (such as RUs, DUs, CU, etc., e.g., cell sites 121 and 122, BBU pool 125, cell sites 123 and 124, and so forth).

It should be noted that other examples may comprise a cellular network with a “non-stand alone” (NSA) mode architecture where 5G radio access network components, such as a “new radio” (NR), “gNodeB” (or “gNB”), and so forth are supported by a 4G/LTE core network (e.g., an EPC network), or a 5G “standalone” (SA) mode point-to-point or service-based architecture where components and functions of an EPC network are replaced by a 5G core network (e.g., an “NC”). For instance, in non-standalone (NSA) mode architecture, LTE radio equipment may continue to be used for cell signaling and management communications, while user data may rely upon a 5G new radio (NR), including millimeter wave communications, for example. However, examples of the present disclosure relate to a hybrid, or integrated 4G/LTE-5G cellular core network such as cellular core network 130 illustrated in FIG. 1. In this regard, FIG. 1 illustrates a connection between AMF 135 and MME 131, e.g., an “N26” interface which may convey signaling between AMF 135 and MME 131 relating to endpoint device tracking as endpoint devices are served via 4G or 5G components, respectively, signaling relating to handovers between 4G and 5G components, and so forth.

In one example, service network 140 may comprise one or more devices for providing services to subscribers, customers, and or users. For example, communication service provider network 101 may provide a cloud storage service, web server hosting, and other services. As such, service network 140 may represent aspects of communication service provider network 101 where infrastructure for supporting such services may be deployed. In one example, other networks 180 may represent one or more enterprise networks, a circuit switched network (e.g., a public switched telephone network (PSTN)), a cable network, a digital subscriber line (DSL) network, a metropolitan area network (MAN), an Internet service provider (ISP) network, and the like. In one example, the other networks 180 may include different types of networks. In another example, the other networks 180 may be the same type of network. In one example, the other networks 180 may represent the Internet in general. In this regard, it should be noted that any one or more of service network 140, other networks 180, or IMS network 150 may comprise a packet data network (PDN) to which an endpoint device may establish a connection via cellular core network 130 in accordance with the present disclosure.

FIG. 1 also illustrates various mobile endpoint devices, e.g., user equipment (UE) 104 and 106. UE 104 and 106 may each comprise a cellular telephone, a smartphone, a tablet computing device, a laptop computer, a pair of computing glasses, a wireless enabled wristwatch, a wireless transceiver for a fixed wireless broadband (FWB) deployment, or any other cellular-capable mobile telephony and computing device (broadly, “an endpoint device”). In one example, each of UE 104 and UE 106 may each be equipped with one or more directional antennas, or antenna arrays (e.g., having a half-power azimuthal beamwidth of 120 degrees or less, 90 degrees or less, 60 degrees or less, etc.), e.g., MIMO antenna(s) to receive multi-path and/or spatial diversity signals. Each of UE 104 and UE 106 may also include a gyroscope and compass to determine orientation(s), a global positioning system (GPS) receiver for determining a location, and so forth. As illustrated in FIG. 1, UE 104 may access wireless services via the cell site 121, while UE 106 may access wireless services via any of cell sites 122-124 located in the access network 120.

In one example, any one or more of the components of cellular core network 130 may comprise network function virtualization infrastructure (NFVI), e.g., SDN host devices (i.e., physical devices) configured to operate as various virtual network functions (VNFs), such as a virtual MME (vMME), a virtual HHS (vHSS), a virtual serving gateway (vSGW), a virtual packet data network gateway (vPGW), and so forth. For instance, MME 131 may comprise a vMME, SGW 132 may comprise a vSGW, and so forth. Similarly, AMF 135, NSSF 136, SMF 137, UDM 138, NWDAF 192, and/or UPF 139 may also comprise NFVI configured to operate as VNFs. In addition, when comprised of various NFVI, the cellular core network 130 may be expanded (or contracted) to include more or less components than the state of cellular core network 130 that is illustrated in FIG. 1.

In this regard, the cellular network 110 may also include a service and management orchestrator (SMO) 190. For instance, in one example, SMO 190 may comprise a self-optimizing network (SON) orchestrator and/or software defined network (SDN) controller. To illustrate, SMO 190 may function as a self-optimizing network (SON) orchestrator that is responsible for activating and deactivating, allocating and deallocating, and otherwise managing a variety of network components. For instance, SMO 190 may activate and deactivate antennas/remote radio heads of cell sites 121 and 122, respectively, may allocate and deactivate baseband units in BBU pool 126, and may perform other operations for activating antennas based upon a location and a movement of an endpoint device or a group of endpoint devices, in accordance with the present disclosure.

In one example, SMO 190 may further comprise a SDN controller that is responsible for instantiating, configuring, managing, and releasing VNFs. For example, in a SDN architecture, a SDN controller may instantiate VNFs on shared hardware, e.g., NFVI/host devices/SDN nodes, which may be physically located in various places. In one example, the configuring, releasing, and reconfiguring of SDN nodes is controlled by the SDN controller, which may store configuration codes, e.g., computer/processor-executable programs, instructions, or the like for various functions which can be loaded onto an SDN node. In another example, the SDN controller may instruct, or request an SDN node to retrieve appropriate configuration codes from a network-based repository, e.g., a storage device, to relieve the SDN controller from having to store and transfer configuration codes for various functions to the SDN nodes.

Accordingly, the SMO 190 may be connected directly or indirectly to any one or more network elements of cellular core network 130, access network 120, and of the system 100 in general. Due to the relatively large number of connections available between SMO 190 and other network elements, none of the actual links to the SON/SDN controller 190 are shown in FIG. 1. Similarly, intermediate devices and links between MME 131, SGW 132, cell sites 121-124, PGW 134, AMF 135, NSSF 136, SMF 137, UDM 138, NWDAF 192, and/or UPF 139, and other components of system 100 are also omitted for clarity, such as additional routers, switches, gateways, and the like.

In one example, SMO 190 may include a RAN intelligent controller (RAN-IC or RIC) 199. For instance, in an O-RAN architecture, the RIC 199 may be deployed for managing and controlling various RAN components/functions, e.g., CUs, DUs, and RUs. For instance, as noted above, RIC 199 may comprise a platform that hosts various RAN applications (e.g., xApps/rApps) that may be used to configure and reconfigure various components of access network 120. In one example, aspects of RIC 199 may represent functionality of an SON orchestrator, or vice versa. In accordance with the present disclosure, RIC 199 may include an RL-based agent, e.g., comprising an RL-based algorithm, or model, for processing execution requests for different RAN applications (e.g., sets of execution requests that may be received in a designated time window).

In one example, RIC 199 and/or SMO 190 may request and/or subscribe to various information that may be obtained and stored by NWDAF 192. Such information may include time-stamped RAN performance indicators (e.g., KPIs for various time blocks/intervals), RAN environment state information (e.g., RAN parameters and/or settings associated with the time blocks/intervals for which performance indicators may be measured/collected), or the like. Alternatively, or in addition RIC 199 and/or SMO 190 may obtain various information from RAN components or other network elements directly (e.g., without NWDAF 192 as an intermediary). In one example, SMO 190 may comprise a computing platform/system hosting various RAN applications, which may comprise programs, code, etc. running on computing hardware of the SMO 190. In one example, the RAN applications may include xApps and rApps.

In one example, RIC 199 may include an RL-based agent, e.g., comprising an RL-based algorithm/model that may be configured with an initial policy, e.g., performing executions requested by RAN application in the order received and/or according to timings as indicated in the requests, and that may learn a new policy over time via a reinforcement learning process that may apply modifications to execution sets in accordance with execution requests from various RAN applications of the SMO 190. For instance, it may be assumed that the interactions among RAN application requests will at least provide a minimum acceptable level of network performance and will not cause unacceptable errors in access network 120 (such as complete loss of network access for a subset of UEs, etc.). For example, before live activation on SMO 190, RAN applications may undergo rigorous testing to ensure that the RAN applications do not negatively impact the network and do not have unacceptable conflicts with other RAN applications (e.g., flagrant conflicts that may be detected by RAN application developers, network operators, or the like during a testing process). As such, default ordering of executions per RAN application execution requests may provide a measurable level of performance, although it may be less than optimal, or less than achievable through reinforcement learning.

For example, NWDAF 192 and/or RIC 199 (or other components of SMO 190) may collect time-stamped RAN performance indicators and RAN environment state information, or the like. From this data, an RL-based agent of RIC 199 may then identify performance indicators having conflicts with each other. For instance, a traffic steering rApp may seek to maximize average UE throughput by off-loading from an overloaded serving cell to one or more neighboring underloaded cells. On the other hand, an energy-saving rApp, may seek to reduce energy consumption by placing underloaded cells into sleep mode, which places these performance indicators in conflict. For example, observing time series of these performance indicators, a negative correlation value may be apparent.

In one example, a malware detection module (MDM) 195 for detecting infected mobile endpoint devices of subscribers through event data records (EDRs) is implemented on an application server 193 in communication with a database (DB) 194. In one embodiment, the DB 194 is tasked with receiving and storing EDRs received from various network elements of the cellular core network 130, the access network 120, the service network 140, the IMS network, 150 and other networks 180. For example, network elements such as MME 131, SGW 132, HSS 133, PGW 134, AMF 135, NSSF 136, SMF 137, UDM 138, UPF 139, SMO 190, NWDAF 192, and/or BBU pool 126 may have the ability to generate EDRs for a plurality of mobile endpoint devices when mobility traffic is being processed. These EDRs can be automatically forwarded to the DB 194 by these network elements or the EDRs can be pulled by the DB on a predefined schedule, e.g., every 30 minutes, every hour, etc.

The present disclosure provides a method and apparatus for detecting infected mobile endpoint devices of subscribers through event data records (EDRs). In one embodiment of the present disclosure, an EDR based malware signature database is generated for use for comparative analysis against EDRs which may potentially serve as indicators of the presence of malware or malicious behavior. This approach of analyzing EDRs for known malware through signature development will allow for centralized analysis, detection and alerting of mobility subscribers that their mobile endpoint devices may be infected with malware.

Malware is a constantly evolving ecosystem which requires frequent updates to remain effective in their detection. As new malware is identified, new signatures and products can be developed to detect and/or simulate the malicious behavior. In a first embodiment, a known malware may be detected on a particular subscriber mobile endpoint device. Based on the detection, the EDR for this particular subscriber mobile endpoint device is obtained and then used to generate an EDR based malware signature for the detected malware. In a second embodiment, a known malware may be obtained, e.g., from a third party provider that specializes in detecting and isolating known malware. The obtained malware can be installed on a dedicated test mobile endpoint device solely for the purpose of simulating the behavior of an infected user mobile endpoint device. The subsequent EDR associated with this test mobile endpoint device is obtained and then used to generate an EDR based malware signature for the installed known malware. Thus, it is possible to replicate the behaviors of an infected client (an infected mobile endpoint device) using mobility simulation tools, and therefore derive a signature or hash for the EDRs specifically constructed and monitored for a given malware event. Either one or both of these approaches can be implemented against an up-to-date database of known malware to generate an EDR based malware signature database (e.g., stored on DB 194) for all of the known malware. As known malware is uncovered, new EDR based malware signatures will be dynamically generated and stored in DB 194. In other words, by iterating through known malware and using mobility traffic of mobility subscribers, a mobility network service provider can build a malware signature database of EDR based malware signatures or hashes that are correlated to known malware to allow for bulk offline analysis against one or more EDR repositories and correlate infected EDRs to specific mobility subscribers (i.e., correlating to specific mobile endpoint devices) for subsequent remediation.

The method of the present disclosure allows for the detection of malware and malicious client behavior without the huge costs associated with packet capture, storage and analysis at scale. The present method allows for a higher level of observability for client behaviors because EDRs are generated for all subscriber behaviors, thereby allowing the re-use of existing EDRs instead of building a parallel system. As noted above, such system would allow for incremental malware signature updates in a single location instead of the distributed nature of having to pushout malware signatures to a distributed security infrastructure, e.g., updating firewalls throughout the entire mobility communication network. Security methods of observing packets in transit within a mobility communication network, often do not have the subscriber-level details, whereas EDRs do. In the present approach, both the Malware, and the infected or offending mobility subscriber endpoint device can be reconciled within the same process as opposed to several other reconciliation processes spanning multiple data sources.

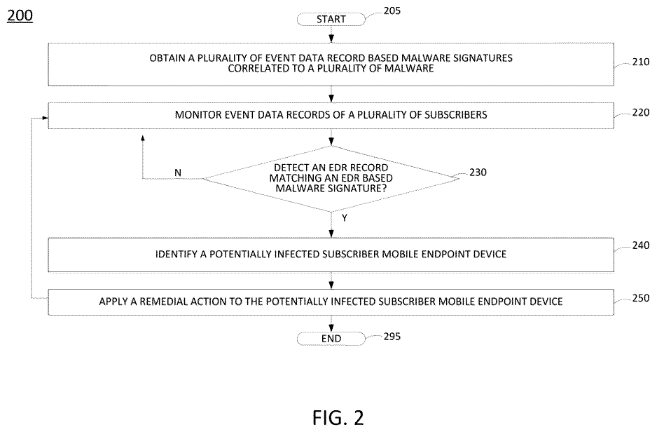

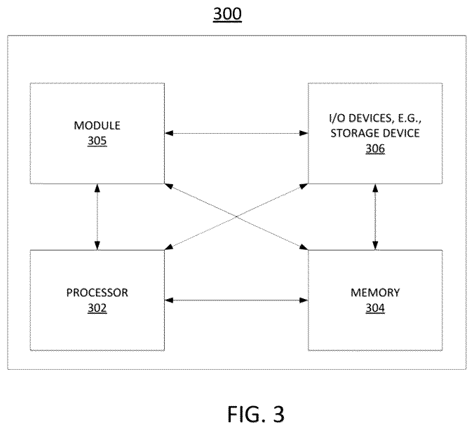

In one example, aspects of the present disclosure for detecting an infected mobile endpoint device of a subscriber through one or more event data records, e.g., as described in greater detail below in connection with the example method 200 of FIG. 2, may be performed by the malware detection module (MDM) 195 via AS 193. In this regard, in one example, AS 193 and/or MDM 195 may comprise all or a portion of a computing device or system, such as computing system 300, and/or processing system 302 as described in connection with FIG. 3 below, and may be configured to perform various operations in connection with examples of the present disclosure for detecting an infected mobile endpoint device of a subscriber through one or more event data records. In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure.

The foregoing description of the system 100 is provided as an illustrative example only. In other words, the example of system 100 is merely illustrative of one network configuration that is suitable for implementing embodiments of the present disclosure. As such, other logical and/or physical arrangements for the system 100 may be implemented in accordance with the present disclosure. For example, the system 100 may be expanded to include additional networks, such as network operations center (NOC) networks, additional access networks, and so forth. The system 100 may also be expanded to include additional network elements such as border elements, routers, switches, policy servers, security devices, gateways, a content distribution network (CDN) and the like, without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For instance, in one example, the cellular core network 130 may further include a Diameter routing agent (DRA) which may be engaged in the proper routing of messages between other elements within cellular core network 130, and with other components of the system 100, such as a call session control function (CSCF) (not shown) in IMS network 150. In another example, the NSSF 136 may be integrated within the AMF 135. In addition, cellular core network 130 may also include additional 5G NG core components, such as: a policy control function (PCF), an authentication server function (AUSF), a network repository function (NRF), and other application functions (AFs).

In one example, any one or more of cell sites 121-123 may comprise 2G, 3G, 4G and/or LTE radios, e.g., in addition to 5G new radio (NR), or gNB functionality. For instance, cell site 123 is illustrated as being in communication with AMF 135 in addition to MME 131 and SGW 132. It should be noted that the example described above involves a 4G-to-5G PDN connection transfer (and 5G-to-4G reversion) that includes UE 106 transferring from cell site 124 to cell site 122 (and vice versa). However, in another example, UE 106 may establish a 4G session to a PDN via 4G/LTE components of cell site 123, and may be transferred to a 5G connection via 5G components of the same cell site 123 in response to one or more trigger conditions as described above.

In addition, network elements or functions that are illustrating as being deployed in one portion of the communication service provider network 101 may alternatively or additionally be deployed in another portion of the communication service provider network 101. For example, SMO 190 may be deployed in cellular core network 130, within access network 120, or may comprise a distributed computing platform having hardware components within cellular core network 130 and access network 120. As discussed above, in one example, at least a portion of the RL-based exploration may include a network simulation. Thus, for instance, network simulation of different execution sets and modifications thereof may be performed via one or more computing devices, e.g., one or more servers, dedicated to this task, such as components of service network 140 and/or components of other network(s) 180 (e.g., a network simulation system hosted on public cloud infrastructure, or the like). However, in another example, the simulation may be provided by SMO 190 and/or RIC 199. Thus, these and other modifications are all contemplated within the scope of the present disclosure.

FIG. 2 illustrates a flowchart of an example method 200 for detecting an infected mobile endpoint device of a subscriber through one or more event data records, in accordance with the present disclosure. In one example, steps, functions and/or operations of the method 200 may be performed by a device as illustrated in FIG. 1, e.g., AS 193 and/or MDM 195, or any one or more components thereof, such as a processing system, or collectively via a plurality devices in FIG. 1, such as SMO 190 in conjunction with NWDAF 192, cell sites 121 and 122, BBU pool 126, and so forth. In one example, the steps, functions, or operations of method 200 may be performed by a computing device or system 300, and/or a processing system 302 as described in connection with FIG. 3 below. For instance, the computing device 300 may represent at least a portion of AS 193 and/or MDM 195 in accordance with the present disclosure. For illustrative purposes, the method 200 is described in greater detail below in connection with an example performed by a processing system, such as processing system 302. The method 200 begins in step 205 and proceeds to step 210.

At step 210, the processing system may obtain a plurality of event data record based malware signatures correlated to a plurality of malware. As discussed above, in one embodiment a known malware may be detected on a particular subscriber mobile endpoint device. Based on the detection, the one or more EDRs for this particular subscriber mobile endpoint device can be obtained and then used to generate an EDR based malware signature for the detected malware. In a second embodiment, a known malware may be obtained, e.g., from a third party provider that specializes in detecting and isolating known malware. The obtained malware can be installed on a dedicated test mobile endpoint device solely for the purpose of simulating the behavior of an infected user mobile endpoint device. The subsequent one or more EDRs associated with this test mobile endpoint device can be obtained and then used to generate an EDR based malware signature for the installed known malware.

The present disclosure broadly teaches the use of EDRs to derive EDR based malware signatures and to associate “infected” EDRs showing indications of malware infection with specific subscribers (i.e., associated with particular subscriber mobile endpoint devices). However, not every single field of each of the EDRs is used in the present disclosure. Some fields may be used to derive an EDR based malware signature, while other fields of the EDRs may be used to associate a particular subscriber session with the malware. In one example, an N-Tuple (e.g., where N is an integer, e.g., a 5-tuple, a 4-tuple, a 3-tuple, etc.), or Layer-7 traffic can be used to build an EDR based malware signature, whereas the session ID, originating node, timestamps and subscriber-level details can be used only to associate the malware with the specific subscriber and session which originated the malware. The illustrated fields below are extracted from some sample EDRs that are currently in use. However, it should be noted that EDR formats can differ based on vendor implementation, configuration, Deep Packet Inspection (DPI) signatures, etc.

To illustrate, UPF EDRs may contain the following attributes: 1) “sessionId” and 2) “connectionId” with type designation called “uint 64.” “SessionId” is a session Identifier which can be tied to a particular mobility session (SUPI/IMSI) within a Session Management Function (SMF) EDR, whereas “connectionId” is a connection Identifier which can be tied to a particular L4 connection.

In turn, an N-tuple (e.g., 5-tuple) EDR based malware signature can be constructed from various fields. To illustrate, the “ueIpAddress” string includes the IP address of the user endpoint (UE) device that is either the source or destination of the flow or connection, “uePort uint32” includes the transport layer port number used by the UE device, “networkIpAddress string” includes the IP address of the destination that the UE device is communicating with, “networkPort uint32” includes the transport layer port number used by the destination of the flow or connection, and “protocol uint32” includes the transport layer protocol ID. Thus, in on embodiment, these five (5) fields can be used to construct an EDR based malware signature. For example, the MDM 195 may discover that a particular first malware may cause a first unique set of values to be associated with this 5-tuple of EDR fields, whereas a particular second malware may cause a second unique set of values to be associated with this 5-tuple of EDR fields. Thus, in one embodiment, the MDM 195 may monitor this 5-tuple of EDR fields for all EDRs for all subscribers in order to detect the presence of the first malware and/or the second malware. It should be noted that different malware may have different N-tuple of EDR fields serving as their respective EDR based malware signatures. For example, the MDM 195 may discover that a particular first malware may cause a first unique set of values to be associated with a first particular 5-tuple of EDR fields, whereas a particular second malware may cause a second unique set of values to be associated with a second completely different or partially different 5-tuple of EDR fields.

It should also be noted that the string “dpiStringInfo” can also be used for EDR based malware signature if particular DPI signatures are in use. Similarly, the time value for “connectioncreationtime” which represents the timestamp when the flow or connection was created and the time value for “connectionlastaccesstime” which represents the timestamp when the data was present on the flow or connection can also be used for EDR based malware signature generation. Furthermore, there are various statistics fields in the EDRs. To illustrate, “upLinkOctets” represents a number of uplink octets received, “upLinkPackets” represents a number of uplink packets received, “downLinkOctets” represents a number of downlink octets received, “downLinkPackets” represents a number of downlink packets received, “upLinkDropOctets” represents a number of uplink octets dropped, “upLinkDropPackets” represents a number of uplink packets dropped, “downLinkDropOctets” represents a number of downlink octets dropped, and “downLinkDropPackets” represents a number of downlink packets dropped.

Thus, numerous different fields of the EDRs can be used for EDR based malware signature generation. The selection of the particular fields of the EDRs will be premised on whether a unique signature or hash can be deduced and attributable to a particular malware or a family of malware.

In one embodiment, the generated EDR based malware signature can be optionally enhanced or enriched with additional supplemental information, e.g., Deep Packet Inspection (DPI) data enrichment. Some examples of supplemental information or attributes may include: 1) “applicationAttributes” that may indicate an application attribute of an application used for this connection such as voice data, video data, etc., 2) “transferredContent” that may specify the content type attribute of the content transferred such as the encoding method that was used, e.g., Moving Picture Experts Group (MPEG) 2 encoding, MPEG 4 encoding etc., 3) “protocolAttributes” that may specify an protocol attribute such as File Transfer Protocol (FTP) Control, FTP data, Hypertext Transfer Protocol (HTTP) connect, Tunnel, etc., and 4) “operatingSystem” that may specify the operating system attribute of the device for this connection, e.g., Windows™, Linux™, OSX™, iOS™, Android™, WindowsMobile™, WindowsPhone™, Chrome™ and Darwin™. Again, the selection of the particular fields of supplemental information will be premised on whether a unique signature or hash can be deduced and attributable to a particular malware or a family of malware. For example, a particular malware may be crafted to target a mobile endpoint device using a particular operating system. Thus, for the above example the generation of a particular EDR based malware signature may include the supplemental information of a particular operating system as part of its malware signature. In one embodiment, the selection of the most relevant N-tuple EDR fields and/or supplemental information is based on the application of the trained machine learning model. In other words, the trained machine learning model may be able to deduce the most pertinent N-tuple EDR fields and/or supplemental information over a period of time as it processes and analyzes a large volume of EDRs. Furthermore, as new malware are discovered, the trained machine learning model can be taken off line and retrained using new EDRs that are conclusively associated with the newly detected malware.

Returning back to FIG. 2, at step 220, the processing system may monitor event data records of a plurality of subscribers associated with a mobility communication network. For example, the MDM 195 may perform the monitoring step of 220 by applying the plurality of event data record based malware signatures obtained in step 210 to the EDRs for the subscribers stored in DB 194 in an attempt to detect any EDRs that would match one or more EDR based malware signatures. In other words, the monitoring step 220 comprises a comparing step. It should be noted that each EDR based malware signature may match to one or more EDRs. In other words, certain EDR based malware signatures can be matched to a single event data record on a one to one basis. However, certain other EDR based malware signatures can be matched to a plurality of event data records on a one to multiple basis, e.g., the EDR based malware signature may require matching to two or more different types of event data records received from two or more different types of network elements as shown in FIG. 1.

At step 230, the processing system determines whether an event data record has matched an EDR based malware signature. If an event data record did not match one of the plurality of EDR based malware signatures, the method returns to step 220 and selects another event data record to perform the comparison against the plurality of EDR based malware signatures. If an event data record did match one of the plurality of EDR based malware signatures, the method proceeds to step 240.

At step 240, the processing system identifies at least one subscriber mobile endpoint device correlated with the event data record that matched one of the plurality of EDR based malware signatures. In other words, the processing system is able to attribute the particular event data record to a particular mobile endpoint device of a particular subscriber of the mobility communication network.

At step 250, the processing system selects and applies a remedial action to be applied to the potentially infected subscriber mobile endpoint device, e.g., an action to be taken in response to having identified the subscriber mobile endpoint device as being infected with a particular malware. For example, one or more remedial actions can be taken once the presence of malware is suspected, e.g., sending an update software patch to an infected mobile endpoint device to remove or uninstall the pertinent malware, quarantine the traffic of an infected mobile endpoint device to a dedicated part of the communication network, e.g., a particular slice of the communication network, a honey pot, and the like, or notifying a security system of the mobility communication network to monitor and uncover the malicious behaviors to discover the originating source of the malware or to discover the true intention of the malware, e.g., detecting the type of personal information being stolen, detecting the destination that the stolen information is being sent and aggregated, and/or detecting that the infected mobile endpoint device is being recruited for a future botnet attack, etc.

In other words, once a malware has been detected and associated to a particular subscriber, one or more actions can be taken to mitigate the risk to the subscriber, the mobility network infrastructure 130, or other third parties, e.g., the other networks 180 of FIG. 1. For example, policy actions can be enacted against specific mobility subscribers to connect their mobile endpoint devices to a quarantined and isolated network, e.g., a particular slice of the network. Once in a quarantined environment, an in-line proxy could then be used to redirect infected subscribers mobile endpoint devices to a portal which can direct these infected mobile endpoint devices to perform specific remediation steps for the found vulnerability or malware. Carriers or network service providers could also use patching methods to directly interact with the infected mobile endpoint devices to both clean or patch these mobile endpoint devices by sending messages out-of-band as done traditionally e.g., when patching subscriber devices'operating systems. Notifications, in the form of a text message, could also be sent to the subscriber mobile endpoint device to supply a link to remediation tools, resources or customer care contacts.

After the remedial action is applied, the method 200 may return to step 220 and select another event data record to perform the comparison against the plurality of EDR based malware signatures. Alternatively, method 200 may end in step 295 or even return to step 210 and obtain updates as to potentially new event data record based malware signatures correlated to a plurality of new malware. For example, method 200 may dynamically return to step 210 if a new malware signature has been discovered or after a predefined period time has elapsed (e.g., after 24 hours, after three days, after a week, after two weeks, and so on).

It should be noted that the method 200 may be expanded to include additional steps or may be modified to include additional operations with respect to the steps outlined above. In one example, various steps of the method 200 may be repeated for the same or different types of EDRs, for the same or different types of EDRs for a different time period, and so forth. For instance, the processing system may repeat steps 210-240 for additional or specific sets of EDRs, and so forth. In one example, the method 200 may be expanded to further include training of the machine learning algorithm via newly detected malware and/or newly generated EDR based malware signatures. For instance, the processing system may simulate new sets of EDRs using newly discovered malware. In one example, the method 200 may be expanded or modified to include steps, functions, and/or operations, or other features described above in connection with the example(s) of FIGS. 1-2, or as described elsewhere herein. Thus, these and other modifications are all contemplated within the scope of the present disclosure.

In addition, although not specifically specified, one or more steps, functions, or operations of the example, method 200 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIG. 2 that recite a determining operation or involve a decision do not necessarily require that both branches of the determining operation be practiced. In other words, one of the branches of the determining operation can be deemed as an optional step. Furthermore, steps, blocks, functions or operations of the above described method(s) can be combined, separated, and/or performed in a different order from that described above, without departing from the examples of the present disclosure.

FIG. 3 depicts a high-level block diagram of a computing device or processing system specifically programmed to perform the functions described herein. As depicted in FIG. 3, the processing system 300 comprises one or more hardware processor elements 302 (e.g., a central processing unit (CPU), a microprocessor, or a multi-core processor), a memory 304 (e.g., random access memory (RAM) and/or read only memory (ROM)), a module 305 for detecting an infected mobile endpoint device of a subscriber through one or more event data records, and various input/output devices 306 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). In accordance with the present disclosure input/output devices 306 may also include antenna elements, antenna arrays, remote radio heads (RRHs), baseband units (BBUs), transceivers, power units, and so forth. Although only one processor element is shown, it should be noted that the computing device may employ a plurality of processor elements. Furthermore, although only one computing device is shown in the figure, if the method(s) as discussed above is/are implemented in a distributed or parallel manner for a particular illustrative example, i.e., the steps of the above method(s) is/are implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 302 can also be configured or programmed to cause other devices to perform one or more operations as discussed above. In other words, the hardware processor 302 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method(s). In one example, instructions and data for the present module or process 305 for detecting an infected mobile endpoint device of a subscriber through one or more event data records (e.g., a software program comprising computer-executable instructions) can be loaded into memory 304 and executed by hardware processor element 302 to implement the steps, functions, or operations as discussed above in connection with the illustrative method(s). Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 305 for detecting an infected mobile endpoint device of a subscriber through one or more event data records (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method comprising:
obtaining, by a processing system including at least one processor, a plurality of event data record based malware signatures;
monitoring, by the processing system, a plurality of event data records associated with a mobility communication network;
detecting, by the processing system, at least one event data record of the plurality event data records matching at least one event data record based malware signature of the plurality of event data record based malware signatures; and
performing, by the processing system, at least one remedial action for a mobile endpoint device of a subscriber associated with the at least one event data record matching the at least one event data record based malware signature.

2. The method of claim 1, wherein the processing system comprises an application server deployed within the mobility communication network for detecting malware.

3. The method of claim 2, wherein the application server employs a machine learning model to perform at least one function of a malware detection module for detecting the malware.

4. The method of claim 1, further comprising:
determining, by the processing system, the mobile endpoint device is associated with the subscriber using the at least one event data record.

5. The method of claim 4, wherein the determining the mobile endpoint device is associated with the subscriber using only the at least one event data record.

6. The method of claim 1, wherein each of the plurality of event data record based malware signatures is generated by using an event data record associated with a mobile endpoint device having been infected with a known malware.

7. The method of claim 6, wherein the using the event data record associated with the mobile endpoint device having been infected with the known malware comprises using less than all fields of the event data record.

8. The method of claim 7, wherein the each of the plurality of event data record based malware signatures comprises an N-Tuple event data record based malware signature, where N is an integer value.

9. The method of claim 8, wherein the N-Tuple event data record based malware signature comprises N fields of a respective event data record correlated with the each of the plurality of event data record based malware signatures.

10. The method of claim 9, wherein the N fields comprise at least two of: an internet protocol address field of a user endpoint device that is a source of a flow, an internet protocol address field of a user endpoint device that is a destination of a flow, a transport layer port number used by the user endpoint device, a transport layer port number used by the destination of the flow, or a transport layer protocol identification.

11. The method of claim 1, wherein each of the plurality of event data record based malware signatures is generated by applying a respective known malware to a test mobile endpoint device, where a subsequent respective event data record associated with this test mobile endpoint device is obtained and used to generate each respective event data record based malware signature.

12. The method of claim 11, wherein less than all fields of the subsequent respective event data record is used to generate the each respective event data record based malware signature.

13. The method of claim 12, wherein the each of the plurality of event data record based malware signatures comprises an N-Tuple event data record based malware signature, where N is an integer value.

14. The method of claim 13, wherein the N-Tuple event data record based malware signature comprises N fields of a respective event data record correlated with the each of the plurality of event data record based malware signatures.

15. The method of claim 14, wherein the N fields comprise at least two of: an internet protocol address field of a user endpoint device that is a source of a flow, an internet protocol address field of a user endpoint device that is a destination of a flow, a transport layer port number used by the user endpoint device, a transport layer port number used by the destination of the flow, or a transport layer protocol identification.

16. The method of claim 1, wherein the at least one event data record based malware signature comprises supplemental information.

17. The method of claim 16, wherein the supplemental information comprises at least one of: an application attribute of an application used for a flow, a content type attribute of content transferred for a flow, a protocol attribute for a flow, or an operating system attribute of a mobile endpoint device for a flow.

18. The method of claim 1, wherein the at least one remedial action comprises at least one of: sending an update software patch to the mobile endpoint device, quarantining traffic of the mobile endpoint device, sending a notification to the subscriber, or notifying a security system of the mobility communication network to monitor the mobile endpoint device to discover an originating source of a malware associated with the at least one event data record based malware signature.

19. A non-transitory computer-readable medium storing instructions which, when executed by a processing system including at least one processor, cause the processing system to perform operations, the operations comprising:
obtaining a plurality of event data record based malware signatures;
monitoring a plurality of event data records associated with a mobility communication network;
detecting at least one event data record of the plurality event data records matching at least one event data record based malware signature of the plurality of event data record based malware signatures; and
performing at least one remedial action for a mobile endpoint device of a subscriber associated with the at least one event data record matching the at least one event data record based malware signature.

20. An apparatus comprising:
a processing system including at least one processor; and
a computer-readable medium storing instructions which, when executed by the processing system, cause the processing system to perform operations, the operations comprising:
obtaining a plurality of event data record based malware signatures;
monitoring a plurality of event data records associated with a mobility communication network;
detecting at least one event data record of the plurality event data records matching at least one event data record based malware signature of the plurality of event data record based malware signatures; and
performing at least one remedial action for a mobile endpoint device of a subscriber associated with the at least one event data record matching the at least one event data record based malware signature.
